(19) United States
(12) Patent Application Publication
(10) Pub. No.: US 2023/0069288 A1
(43) Pub. Date: Mar. 2, 2023

(54) MOTOR AND ELECTRIC COMPRESSOR

(71) Applicant: SANDEN CORPORATION, Isesaki-shi, Gunma (JP)

(72) Inventor: Makoto YOSHIDA, Isesaki-shi, Gunma (JP)

(73) Assignee: SANDEN CORPORATION, Isesaki-shi, Gunma (JP)

(21) Appl. No.: 17/904,330

(22) PCT Filed: Feb. 19, 2021
(86) PCT No.: PCT/JP2021/006363

§ 371 Date: Aug. 16, 2022

(30) Foreign Application Priority Data
Feb. 25, 2020 (JP) 2020-029032

(51) Int. Cl. H02K 1/14; H02K 21/16; F25B 31/02

(52) U.S. Cl. CPC H02K 1/148; H02K 21/16; F25B 31/026; F04C 2/025

(57) ABSTRACT

PROBLEM TO BE SOLVED To improve controllability of a motor including a stator with two-split structure.

SOLUTION
A motor 400 includes a stator 460 disposed to surround an outer circumference of a rotor 440 which rotates integrally with a drive shaft 420. The stator 460 includes an inner core 462 having multiple protrusions 462B radially outwardly extending from an outer circumferential surface of a cylindrical portion 462A, and a cylindrical outer core 464 having its inner circumferential surface side attached to a top of the protrusion 462B. A connection portion (first connection portion 462F) as a part for connecting a side surface (first side surface 462D) of the protrusion 462B at an upstream side in a rotating direction of the rotor 440 and an outer circumferential surface of the cylindrical portion 462A has a rounded shape. A connection portion (second connection portion 462G) as a part for connecting a side surface (second side surface 462E) of the protrusion 462B at a downstream side in the rotating direction of the rotor 440 and the outer circumferential surface of the cylindrical portion 462A has a rounded shape. A radius r1 of the rounded shape of the first connection portion 462F is greater than a radius r2 of the rounded shape of the second connection portion 462G.

### TECHNICAL FIELD

The present invention relates to a motor used for a compressor or the like which compresses a fluid, and to an electric compressor mounted with the motor.

### BACKGROUND ART

Conventionally, various kinds of stators, each with two-split structure including an inner core and an outer core, have been proposed for use as a motor stator. The inner core, for example, includes a cylindrical portion, and multiple protrusions extending radially outward from an outer circumferential surface of the cylindrical portion. The outer core is cylindrically shaped, and it has an inner circumferential surface side attached to a top of the protrusion of the inner core. The stator with two-split structure is disclosed in Patent Document 1.

### REFERENCE DOCUMENT LIST

### Patent Document

Patent Document 1: Japanese Patent Laid-Open No.11-98724

### SUMMARY OF THE INVENTION

### Problem to be Solved by the Invention

The foregoing stator with two-split structure has caused the problem as described below. That is, the magnetic flux flowing around an area of the cylindrical portion of the inner core, which connects circumferentially adjacent protrusions, enlarges the motor inductance to increase the voltage phase angle, resulting in deteriorated controllability.

It is an object of the present invention to attain improvement in controllability of the motor having the stator with two-split structure as described above.

### Means for Solving the Problem

According to a first aspect of the present invention, the motor includes a drive shaft for transmitting a rotation drive force, a rotor which rotates integrally with the drive shaft, and a stator disposed to surround an outer circumference of the rotor. The stator includes an inner core having multiple protrusions extending radially outwardly from an outer circumferential surface of a cylindrical portion, and a cylindrical outer core having its inner circumferential surface side attached to a top of the protrusion of the inner core. A first connection portion as a part for connecting a side surface of the protrusion at an upstream side in a rotating direction of the rotor and an outer circumferential surface of the cylindrical portion has a rounded shape. A second connection portion as a part for connecting a side surface of the protrusion at a downstream side in the rotating direction of the rotor and the outer circumferential surface of the cylindrical portion has a rounded shape. A radius of the rounded shape of the first connection portion is greater than a radius of the rounded shape of the second connection portion.

According to a second aspect of the present invention, the electric compressor is mounted with the motor according to the first aspect.

### Effects of the Invention

According to the present invention, for each protrusion, the magnetic flux flow is facilitated around the first connection portion, and it is blocked around the second connection portion. It is possible to suppress flow of the magnetic flux at the cylindrical portion of the inner core, which connects the circumferentially adjacent protrusions. Accordingly, the voltage phase angle can be reduced to improve controllability of the motor.

### BRIEF DESCRIPTION OF THE DRAWINGS

FIG. 1 is a vertical sectional view of an example of a scroll compressor.

FIG. 2 is a block diagram representing a flow of a gas refrigerant and a lubricant.

FIG. 3 is a perspective view of an example of a stator to which a bobbin is attached.

FIG. 4 is a sectional view of an example of a motor.

FIG. 5 is a partially enlarged view of a part P of FIG. 4.

FIG. 6 is a vector diagram indicating voltage phase angles of the motor before and after improvement.

### MODE FOR CARRYING OUT THE INVENTION

An embodiment for implementing the present invention will be described in detail referring to the drawings.

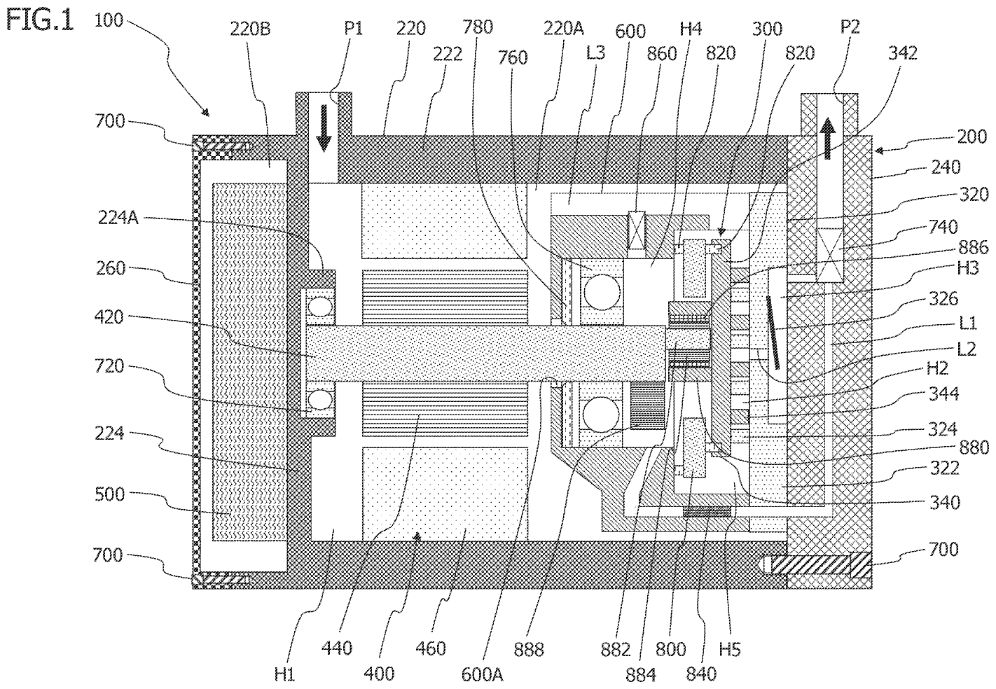

FIG. 1 illustrates an example of a scroll compressor 100 having a motor according to the embodiment incorporated therein. The electric compressor is exemplified by the scroll compressor 100.

The scroll compressor 100 is incorporated in a refrigerant circuit of an air conditioner for vehicle, for example. The scroll compressor 100 compresses a gas refrigerant (fluid) drawn from a low-pressure side of the refrigerant circuit, and discharges the compressed refrigerant, for example. The scroll compressor 100 includes a housing 200, a scroll unit 300, a motor 400, an inverter 500, and a support member 600. The scroll unit 300 compresses the low-pressure gas refrigerant. The motor 400 drives the scroll unit 300. The inverter 500 controls the motor 400. The support member 600 rotatably supports a rear part of a drive shaft 420 extending along a front-rear direction of the motor 400 via a bearing 760. It is possible to use, for example, CO2 (carbon dioxide) refrigerant for the refrigerant in the refrigerant circuit. The scroll compressor 100 which is separated from the inverter can be employed instead of the one integrated with the inverter in the exemplified case.

The housing 200 has a front housing 220, a rear housing 240, and an inverter cover 260. The front housing 220 houses the scroll unit 300, the motor 400, the inverter 500, and the support member 600. The rear housing 240 is connected to a rear end of the front housing 220. The inverter cover 260 is connected to a front end of the front housing 220. The front housing 220, the rear housing 240, and the inverter cover 260 are fastened and integrally assembled using multiple fasteners (for example, bolts) 700.

The front housing 220 has a cylindrical circumferential wall 222 and a circular plate-like partition wall 224. The “cylindrical shape” may be recognized to the degree to which such shape appears to be cylindrical. For example, the reinforcement rib or the mounting boss can be provided on the outer circumferential surface of the part with cylindrical shape (the shape applies hereafter). The internal space (internal space of the circumferential wall 222) of the front housing 220 is partitioned into a first space 220A and a second space 220B by the partition wall 224. Specifically, the partition wall 224 separates the internal space of the circumferential wall 222 into two spaces in the axial direction. The scroll unit 300, the motor 400, and the support member 600 are held in the first space 220A. The inverter 500 is held in the second space 220B.

The circular plate-like rear housing 240 seals a rear end opening of the circumferential wall 222. The inverter cover 260 seals a front end opening of the circumferential wall 222. A cylindrical support portion 224A is formed on a rear surface of the partition wall 224 at the center while extending rearward from the rear surface. The support portion 224A rotatably supports a front end of the drive shaft 420 of the motor 400 via a bearing 720 press fitted with an inner circumferential surface of the support portion 224A.

An intake port P1 for drawing the gas refrigerant is formed in the circumferential wall 222. The gas refrigerant from the refrigerant circuit at the low-pressure side is drawn into the first space 220A of the front housing 220 via the intake port P1. Accordingly, the first space 220A of the front housing 220 serves as a gas refrigerant intake chamber H1. In the intake chamber H1, the gas refrigerant cools the motor 400 by circulating therearound. In the intake chamber H1, the gas refrigerant flows as a fluid mixture containing a very small amount of lubricant.

A discharge port P2 is formed in the rear housing 240. The gas refrigerant compressed by the scroll unit 300 is discharged from the discharge port P2 to the high-pressure side of the refrigerant circuit.

An oil separator 740 is incorporated in the rear housing 240. The oil separator 740 implements a function of separating the lubricant (lubricant oil) from the gas refrigerant which has been compressed by the scroll unit 300. The gas refrigerant (including the gas refrigerant containing a very small amount of residual lubricant), from which the lubricant has been separated by the oil separator 740 is discharged to the high-pressure side of the refrigerant circuit via the discharge port P2. In addition, the lubricant separated by the oil separator 740 is guided into a back pressure supply passage L1 (to be described later).

The scroll unit 300 is stored in the front housing 220 at the rear side. The scroll unit 300 has a fixed scroll 320 and a turning scroll (orbiting scroll) 340. The fixed scroll 320 is fixed to a front surface of the rear housing 240. The turning scroll 340 is disposed to the front of the fixed scroll 320.

The fixed scroll 320 has a circular plate-like bottom plate 322, and an involute curve lap (spiral vane) 324. The bottom plate 322 is fixed to the front surface of the rear housing 240. The lap 324 extends from a front surface of the bottom plate 322 toward the turning scroll 340.

The turning scroll 340 has a circular plate-like bottom plate 342 and an involute curve lap (spiral vane) 344. The bottom plate 342 is disposed to face the bottom plate 322 of the fixed scroll 320. The lap 344 extends from a rear surface of the bottom plate 342 toward the fixed scroll 320.

The fixed scroll 320 and the turning scroll 340 are engaged in the state that angles of the laps 324 and 344 with respect to the circumferential direction are shifted from each other so that the side walls of the laps 324 and 344 are partially in contact with each other. Accordingly, the scroll unit 300 has a crescent-like sealed space defined between the fixed scroll 320 and the turning scroll 340, that is, a compression chamber H2 for compressing the gas refrigerant.

The bottom plate 322 has a recessed discharge chamber H3 in its rear surface at the center. A discharge passage L2 which allows communication between the compression chamber H2 and the discharge chamber H3 is formed through the center of the bottom plate 322 of the fixed scroll 320. The gas refrigerant compressed in the compression chamber H2 is discharged into the discharge chamber H3 via the discharge passage L2, and it is temporarily stored in the discharge chamber H3. The discharge chamber H3 (open end of the discharge passage L2 at the downstream side) is provided with a one-way valve 326 as, for example, a reed valve. The one-way valve 326 allows the gas refrigerant flow from the compression chamber H2 to the discharge chamber H3, and blocks the gas refrigerant flow from the discharge chamber H3 to the compression chamber H2.

For example, the motor 400 is exemplified by a three-phase AC motor. The motor 400 has the drive shaft 420, a rotor 440, and a stator 460. The stator 460 is disposed to surround an outer circumference of the rotor 440 (that is, radially outer side of the rotor 440). For example, a direct current from a battery for a vehicle (not shown) is converted into an alternating current by the inverter 500 for power supply to the stator 460 of the motor 400.

The drive shaft 420 is connected to the turning scroll 340 via a crank mechanism (to be described later). The drive shaft 420 transmits the rotation drive force of the motor 400 to the turning scroll 340.

A shaft hole extending in a front-rear direction (axial direction) is formed through the center of the rotor 440, with which the drive shaft 420 is press fitted. The press fitting operation integrates the rotor 440 with the drive shaft 420. When power supply from the inverter 500 generates the magnetic field in the stator 460, the turning force is applied to the rotor 440 so that the drive shaft 420 is rotationally driven.

The support member 600 is formed into a bottomed cylindrical shape with the same external diameter as that of the bottom plate 322 of the fixed scroll 320, which extends in the front-rear direction (axial direction), and has an inner circumferential surface formed into a stepped columnar shape having the diameter reduced in two stages from the opening side of the rear end toward the bottom wall of the front end. The turning scroll 340 of the scroll unit 300 is held in the space defined by the inner circumferential surface of the support member 600 at a large-diameter side. The opening in the rear end of the support member 600 is fixed to the bottom plate 322 of the fixed scroll 320 using a fastener (not shown), for example.

Consequently, the opening in the rear end of the support member 600 is sealed with the fixed scroll 320. A back pressure chamber H4 which presses the turning scroll 340 against the fixed scroll 320 is defined by the support member 600.

The bearing 760 for rotatably supporting the rear end of the drive shaft 420 of the motor 400 is engaged with an inner circumferential surface of the support member 600 at the small-diameter side. A through hole 600A is formed through a radial center of the bottom wall of the front end of the support member 600 for accommodating insertion of the drive shaft 420. A seal member 780 is disposed between the bearing 760 and the bottom wall to secure air tightness of the back pressure chamber H4.

An annular thrust plate 800 is disposed in a space defined by an inner circumferential surface of the support member 600 at the large-diameter side, that is, in the space defined by a stepped portion between the small-diameter part and the large-diameter part, and the bottom plate 342 of the turning scroll 340. The stepped portion of the support member 600 receives the thrust force from the turning scroll 340 via the thrust plate 800. Seal members 820 are disposed at the stepped portion of the support member 600, and the bottom plate 342 of the turning scroll 340, which are abutted on the thrust plate 800, respectively so that air tightness of the back pressure chamber H4 is secured.

The back pressure supply passage L1 is formed through the rear housing 240, the fixed scroll 320, and the support member 600. The back pressure supply passage L1 is formed to supply the lubricant separated by the oil separator 740 to the back pressure chamber H4. The lubricant supplied from the oil separator 740 to the back pressure chamber H4 is used as the back pressure for pressing the turning scroll 340 against the fixed scroll 320. An orifice 840 for limiting the flow rate of the lubricant is formed in the middle of the back pressure supply passage L1.

A back pressure control valve 860 is disposed in the small-diameter part of the support member 600. The back pressure control valve 860 is operated in accordance with a back pressure Pm of the back pressure chamber H4 and an intake pressure Ps of the intake chamber H1 to adjust the back pressure Pm of the back pressure chamber H4. Specifically, the back pressure control valve 860 is opened when the back pressure Pm of the back pressure chamber H4 is increased to be higher than the target pressure so that the lubricant in the back pressure chamber H4 is discharged to the intake chamber H1. The back pressure Pm of the back pressure chamber H4 is thus reduced. In addition, the back pressure control valve 860 is closed when the back pressure Pm of the back pressure chamber H4 is decreased to be lower than the target pressure so that discharging of the lubricant from the back pressure chamber H4 to the intake chamber H1 is stopped. The back pressure Pm of the back pressure chamber H4 is thus increased. The back pressure control valve 860 adjusts the back pressure Pm of the back pressure chamber H4 to the target pressure.

A refrigerant introduction passage L3 is formed between an inner circumferential surface of the circumferential wall 222 of the front housing 220 and an outer circumferential surface of the support member 600. The refrigerant introduction passage L3 communicates the intake chamber H1 with a space H5 positioned around an outer periphery of the scroll unit 300 so that the gas refrigerant is introduced from the intake chamber H1 to the space H5. The pressure of the space H5 is equal to that of the intake chamber H1.

The crank mechanism has a cylindrical boss 880 which protrudes from a front surface of the bottom plate 342 of the turning scroll 340, a crank pin 882 eccentrically disposed to stand on the rear end surface of the drive shaft 420, an eccentric bush 884 eccentrically attached to a crank pin 882, and a slide bearing 886 engaged with the boss 880. The eccentric bush 884 is supported by the boss 880 relatively rotatably via the slide bearing 886. A balancer weight 888 resisting against centrifugal force of the turning scroll 340 is attached to the rear end of the drive shaft 420. A rotation blocking mechanism (not shown) is provided for blocking rotation of the turning scroll 340. The turning scroll 340 is allowed to revolve around the axial center of the fixed scroll 320 via the crank mechanism while having its rotation blocked.

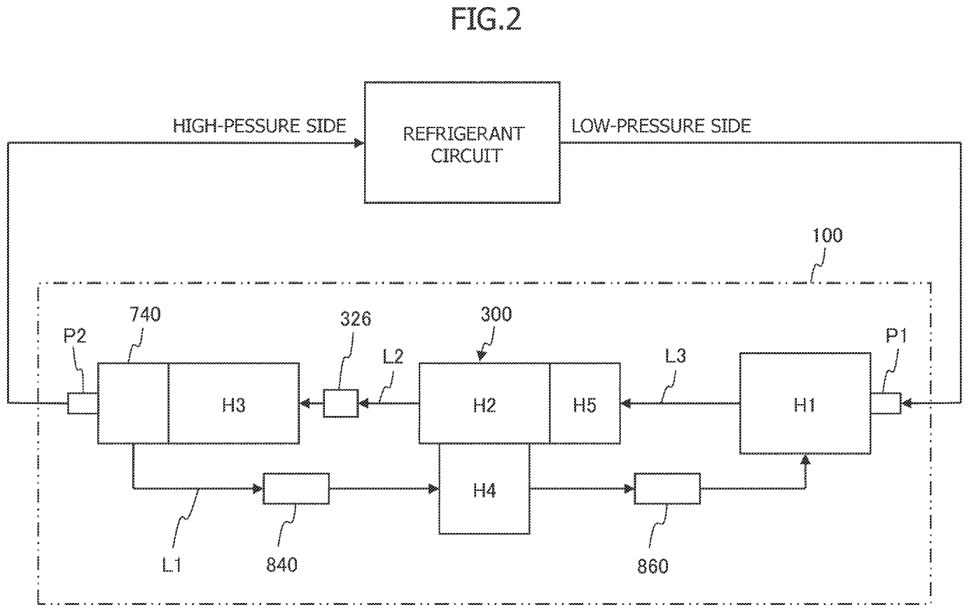

FIG. 2 is a block diagram indicating a flow of the gas refrigerant and the lubricant. The gas refrigerant from the low-pressure side of the refrigerant circuit is introduced into the intake chamber H1 via the intake port P1, and it is then further guided into the space H5 positioned around the outer periphery of the scroll unit 300 via the refrigerant introduction passage L3. The gas refrigerant guided into the space H5 is drawn into the compression chamber H2 of the scroll unit 300, and it is compressed as a result of change in the volume of the compression chamber H2. The gas refrigerant compressed in the compression chamber H2 is discharged into the discharge chamber H3 via the discharge passage L2 and the one-way valve 326, and it is guided to the oil separator 740. The gas refrigerant having the lubricant separated by the oil separator 740 is discharged to the high-pressure side of the refrigerant circuit via the discharge port P2. In addition, the lubricant separated by the oil separator 740 is supplied to the back pressure chamber H4 via the back pressure supply passage L1 while having its flow rate limited by the orifice 840. The lubricant supplied into the back pressure chamber H4 is discharged into the intake chamber H1 via the back pressure control valve 860.

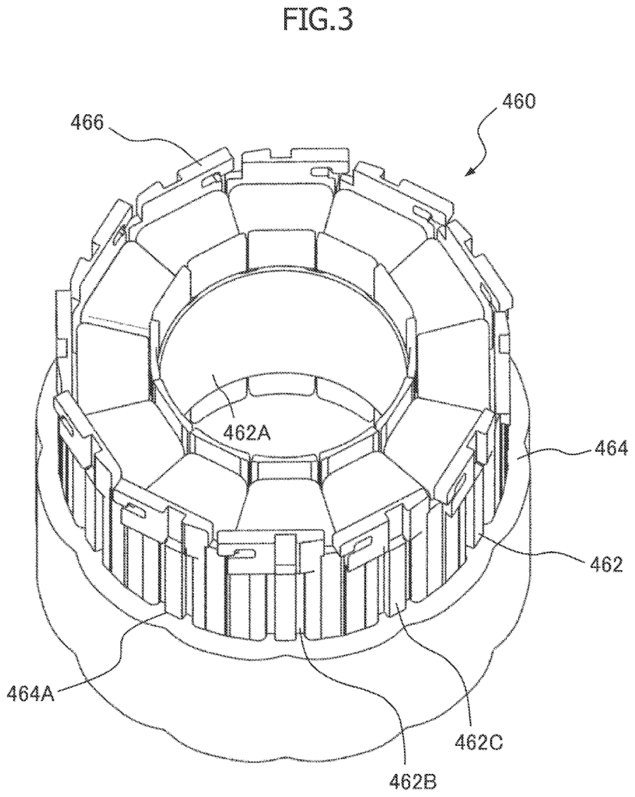

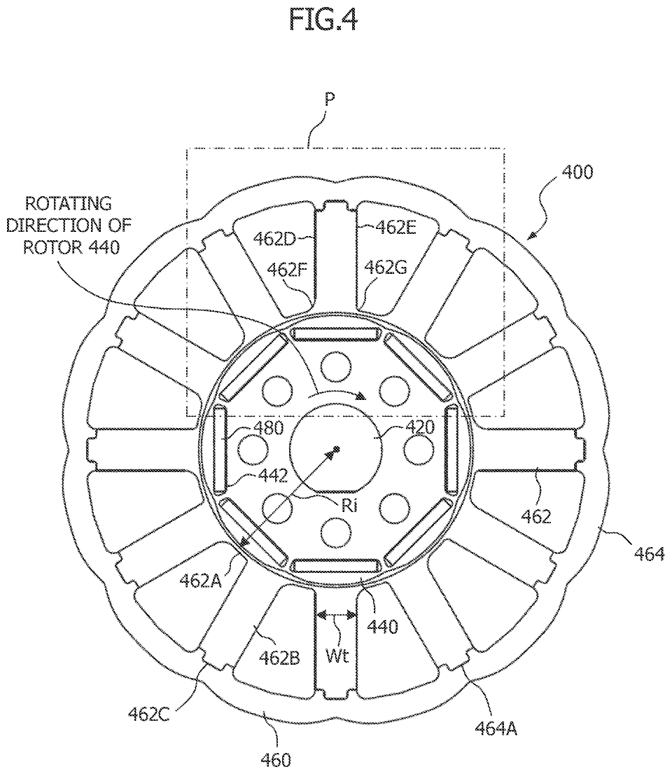

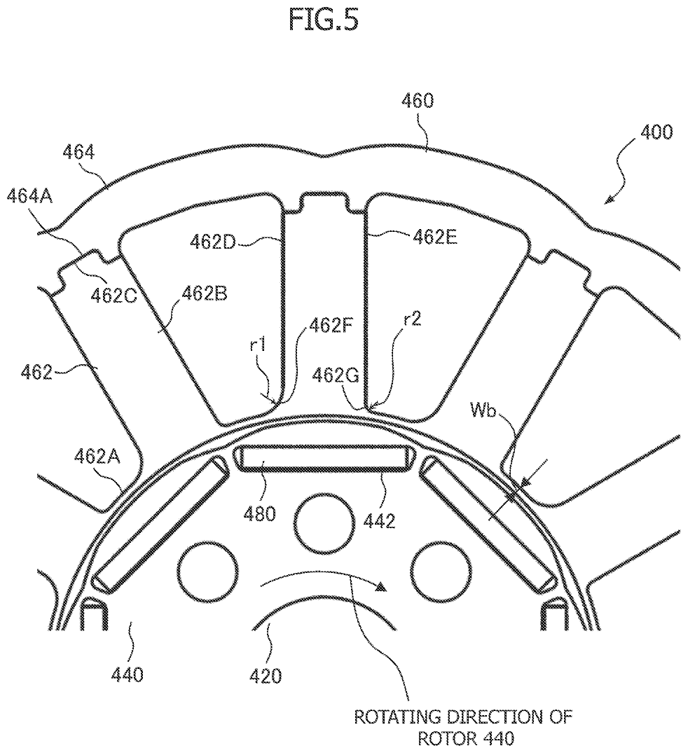

FIG. 3 is a perspective view of an example of the stator 460 with two-split structure, to which a bobbin 466 is attached. FIG. 4 is a sectional view of an example of the motor 400. FIG. 5 is a partially enlarged view of a part P of FIG. 4. FIG. 3 illustrates a state in the middle of press fitting the inner core 462 with the outer core 464.

The stator 460 of the motor 400, for example, employs the two-split structure having the inner core 462 and the outer core 464 integrated through press fitting as illustrated in FIGS. 3 to 5 for the purpose of improving the winding space factor. Each of the inner core 462 and the outer core 464 is formed by laminating multiple steel sheets (for example, electromagnetic steel sheets).

The inner core 462 is an iron core formed by integrating a cylindrical portion 462A, and multiple protrusions 462B which are extending radially outwardly from an outer circumferential surface of the cylindrical portion 462A. A rotor 440 is rotatably inserted into a radially inner side of the cylindrical portion 462A having an air gap therebetween at a predetermined interval.

The protrusions 462B, each of which is a cuboid member, are arranged at equal angle around the center axis of the cylindrical portion 462A. A convex fitting portion 462C is formed on a top of the protrusion 462B. The convex fitting portion 462C is formed along an axis of the inner core 462 across one surface and the other surface thereof

The bobbin 466 wound with wiring is externally inserted from the upper end of the protrusion 462B of the inner core 462 and is fixed thereto. The wiring may be directly wound around the protrusions 462B without using the bobbin 466. In the illustrated example, 12 protrusions 462B are formed on the outer circumferential surface of the cylindrical portion 462A. However, the number of protrusions 462B may be freely set in consideration of required characteristics of the motor 400, for example.

The outer core 464 is a cylindrical iron core, and has multiple recessed fitting portions 464A formed in an inner circumferential surface. The convex fitting portion 462C at the top of the protrusion 462B of the inner core 462 is press fitted with the recessed fitting portion 464A formed along an axis of the outer core 464 across one surface and the other surface thereof. As the convex fitting portion 462C at the top of the protrusion 462B is press fitted with the recessed fitting portion 464A, the inner core 462 and the outer core 464 are rigidly integrated while suppressing relative displacement in the circumferential direction. The press fitting also suppresses the relative displacement in the radial direction. In the foregoing manner, the top of the inner core 462 is attached to an inner circumferential surface side of the outer core 464.

In the rotor 440, circumferentially arranged multiple magnets (permanent magnets) 480 are embedded along an outer circumference which faces the inner circumferential surface of the stator 460. The magnet 480 having a cuboid shape is inserted into a magnet insertion hole 442 which pierces through the rotor 440 along its axis across one surface and the other surface thereof. While the motor 400 is rotating, the magnet 480 is prevented from jumping out from the rotor 440 by centrifugal force. This makes it possible to ensure mechanical safety. In the illustrated example, eight magnets 480 are embedded along the outer circumference of the rotor 440. However, the number of the magnets may be freely determined.

The rotor 440 rotates only in one direction, and it does not rotate in reverse. The explanation will be made referring to FIGS. 4 and 5 on the assumption that the rotor 440 rotates clockwise (CW direction).

The protrusion 462B of the inner core 462 has a first side surface 462D at the upstream side in the rotating direction of the rotor 440, and a second side surface 462E at the downstream side in the rotating direction of the rotor 440. In this embodiment, each of the first side surface 462D and the second side surface 462E is a plane which is substantially orthogonal to the circumferential direction of the stator 460, and also substantially orthogonal to the rotating direction of the rotor 440.

A first connection portion 462F for connection between the first side surface 462D and the outer circumferential surface of the cylindrical portion 462A is accurately curved in a cross section of the stator 460. In other words, the first connection portion 462F is rounded-shaped. A second connection portion 462G for connection between the second side surface 462E and the outer circumferential surface of the cylindrical portion 462A is accurately curved in a cross section of the stator 460. In other words, the second connection portion 462 is rounded-shaped.

In the embodiment, a radius r1 of the rounded shape of the first connection portion 462F is greater than a radius r2 of the rounded shape of the second connection portion 462G.

An example of a method for determining the radii r1, r2 will be described.

In the example, the following formula (1) is used to obtain an auxiliary angle θ[rad].

θ=(π/2)−(π/Ns) (1)

In the formula (1), the term “Ns” is defined as follows: Ns: the number of slots of the motor 400.

Based on the result calculated from the formula (1), the maximum radius rmax [mm] of the rounded shape which can be formed in the slot of the motor 400 is obtained using the following formula (2).

rmax=(Ri·cos θ+Wb·cos θ−0.5·Wt)/(1−cos θ) (2)

In the formula (2), the terms “Ri”, “Wb”, and “Wt” are defined as follows:
Ri [mm]: inside radius of the stator 460 (inside radius of the cylindrical portion 462A);
Wb [mm]: width of the thinnest part of the cylindrical portion 462A; and
Wt [mm]: width of the protrusion 462B (distance between the side surfaces 462D and 462E)

Based on the result calculated from the formula (2), the radius r1 is determined so that the following formula (3) is satisfied.

0.35·rmax≤r1≤0.65·rmax (3)

Based on the result calculated from the formula (3), the radius r2 is determined so that the following formula (4) is satisfied.

t≤r2≤0.65·r1 (4)

In the formula (4), the term “t” is defined as follows: t [mm]: thickness of the single steel sheet (for example, electromagnetic steel sheet).

In other words, the radius r1 of the rounded shape of the first connection portion 462F may be determined to be in the range from 0.35 to 0.65 times (inclusive) the maximum radius rmax of the rounded shape that can be formed in the slot of the motor 400. The maximum radius rmax can be obtained based on the inside radius of the stator 460 (inside radius of cylindrical portion 462A) Ri, the width Wb of the thinnest part of the cylindrical portion 462A, the width of the protrusion 462B (distance between the first side surface 462D and the second side surface 462E) Wt, and the auxiliary angle θ. The auxiliary angle θ may be calculated based on the number of slots N of the motor 400.

The radius r2 of the rounded shape of the second connection portion 462G is equal to, or greater than, the thickness t of the single steel sheet (for example, electromagnetic steel sheet) constituting the inner core 462, and can be determined to be in the range that is equal to or less than half the radius r1 of the rounded shape of the first connection portion 462F.

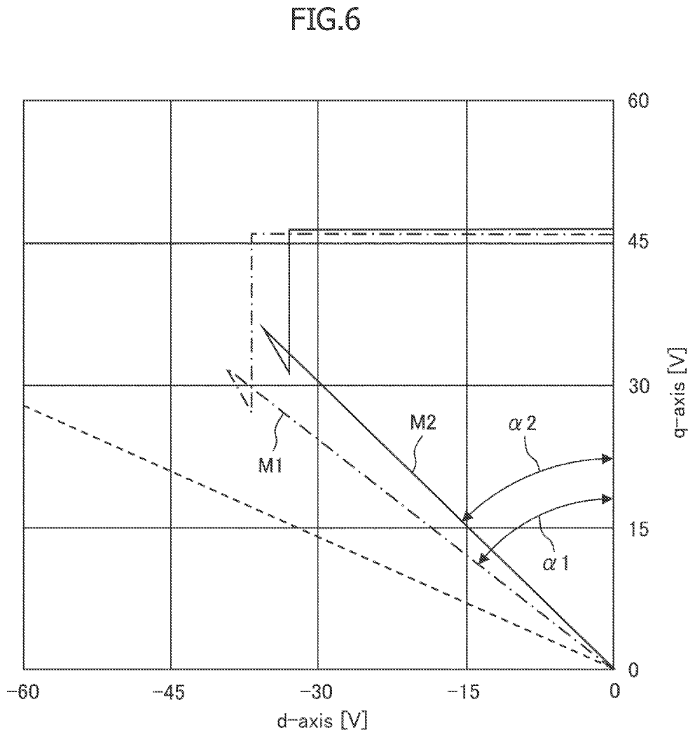

An effect of the embodiment will be described referring to FIG. 6 in addition to FIGS. 1 to 5. FIG. 6 is a vector diagram of the voltage phase angles of a motor M1 before improvement, and a motor M2 after improvement. The radii r1 and r2 of the motor M1 as the motor 400 before improvement are equal. The radius r1 of the motor M2 as the motor 400 after improvement is greater than the radius r2. The radius r1 is set to 1.6 mm, and the radius r2 is set to 0.5 mm when forming the vector diagram of the voltage phase angle of the improved motor M2.

A voltage phase angle α1 as shown in FIG. 6 is derived from the motor M1 before improvement. The voltage phase angle α2 is derived from the motor M2 after improvement. As FIG. 6 clearly shows, making the radius r1 greater than the radius r2 results in the voltage phase angle being less than the one obtained from the case in which the radius r1 is equal to the radius r2. Improvement in the controllability can be easily understood.

According to the embodiment, the motor 400 to be mounted in the scroll compressor 100 as an example of the electric compressor includes the drive shaft 420 for transmitting a rotation drive force, the rotor 440 which rotates integrally with the drive shaft 420, and the stator 460 disposed to surround an outer circumference of the rotor 440. The stator 460 includes the inner core 462 having multiple protrusions 462B radially outwardly extending from the outer circumferential surface of the cylindrical portion 462A, and the cylindrical outer core 464 having its inner circumferential surface side attached to the top of the protrusion 462B of the inner core 462. The first connection portion 462F as the part for connecting the side surface (first side surface 462D) of the protrusion 462B at the upstream side in the rotating direction of the rotor 440 and the outer circumferential surface of the cylindrical portion 462A has the rounded shape. The second connection portion 462G as the part for connecting the side surface (second side surface 462E) of the protrusion 462B at the downstream side in the rotating direction of the rotor 440 and the outer circumferential surface of the cylindrical portion 462A has the rounded shape. The radius r1 of the rounded shape of the first connection portion 462F is greater than the radius r2 of the rounded shape of the second connection portion 462G. This suppresses the flow of the magnetic flux at a part of the cylindrical portion 462A of the inner core 462, which connects the circumferentially adjacent protrusions 462B. The voltage phase angle of the motor 400 can be made smaller, resulting in improved controllability of the motor 400.

In the embodiment, the inner core 462 is formed of multiple steel sheets (for example, electromagnetic steel sheets) which are laminated. The radius r2 of the rounded shape of the second connection portion 462G is equal to, or greater than, the thickness t of a single sheet of the steel sheet. This makes it possible to manufacture the inner core 462 by accurately punching the steel sheet using the press machine. Preferably, the radius r2 of the rounded shape of the second connection portion 462G is equal to, or less than, half the radius r1 of the rounded shape of the first connection portion 462F.

In the embodiment, the circumferentially arranged multiple magnets (permanent magnets) 480 are embedded along the outer circumference of the rotor 440. The protrusion 462B appropriately receives magnetism of the magnet 480 in the rotor 440 from the first connection portion 462F. The magnetic flux flow is blocked at the second connection portion 462G. This makes it possible to suppress the flow (routing) of the magnetic flux in the counterclockwise direction (CCW direction) from the protrusion 462B at the downstream side in the rotating direction of the rotor 440 toward the protrusion 462B at the upstream side in the rotating direction of the rotor 440 through the cylindrical portion 462A between the adjacent protrusions. The magnetic flux flow in the CCW direction blocks the rotation of the rotor 440 in the CW direction. Suppression of the magnetic flux flow in the CCW direction can make the voltage phase angle of the motor 400 small, resulting in improved controllability.

The embodiment for carrying out the present invention has been described. The present invention, however, is not limited to the embodiment, and it may be variously modified and changed based on the technical ideas as exemplified below.

The electric compressor may be exemplified by, for example, a centrifugal compressor, an axial compressor, a reciprocating compressor, a swash plate compressor, a diaphragm type compressor, a screw compressor, a rotary compressor, a rotary piston compressor, and a sliding vane compressor, without being limited to the scroll compressor 100. The back pressure control valve 860 may be configured to increase or decrease the flow rate of the lubricant supplied to the back pressure chamber H4 so that the back pressure Pm of the back pressure chamber H4 is adjusted to the target pressure.

### REFERENCE SYMBOL LIST

100 Scroll compressor (electric compressor)
400 Motor
420 Drive shaft
440 Rotor
460 Stator
462 Inner core
462A Cylindrical portion
462B Protrusion
462C Convex fitting portion
462D First side surface
462E Second side surface
462F First connection portion
462G Second connection portion
464 Outer core
464A Recessed fitting portion
466 Bobbin
480 Magnet
r1, r2, Ri Radius
Wb, Wt Width

1. A motor including a drive shaft for transmitting a rotation drive force, a rotor which rotates integrally with the drive shaft, and a stator disposed to surround an outer circumference of the rotor, wherein:
the stator includes an inner core having multiple protrusions radially outwardly extending from an outer circumferential surface of a cylindrical portion, and a cylindrical outer core having its inner circumferential surface side attached to a top of the protrusion of the inner core;
a first connection portion as a part for connecting a side surface of the protrusion at an upstream side in a rotating direction of the rotor and an outer circumferential surface of the cylindrical portion has a rounded shape;
a second connection portion as a part for connecting a side surface of the protrusion at a downstream side in the rotating direction of the rotor and the outer circumferential surface of the cylindrical portion has a rounded shape; and
a radius of the rounded shape of the first connection portion is greater than a radius of the rounded shape of the second connection portion.

2. The motor according to claim 1, wherein:
the inner core is formed of multiple steel sheets which are laminated; and
the radius of the rounded shape of the second connection portion is equal to, or greater than, a thickness of a single sheet of the steel sheet.

3. The motor according to claim 1, wherein the radius of the rounded shape of the second connection portion is equal to, or less than, half the radius of the rounded shape of the first connection portion.

4. The motor according to claim 1, wherein circumferentially arranged multiple magnets are embedded along an outer circumference of the rotor.

5. An electric compressor mounted with the motor according to . claim 1.

6. The motor according to claim 2, wherein the radius of the rounded shape of the second connection portion is equal to, or less than, half the radius of the rounded shape of the first connection portion.
